(19) United States
(12) Patent Application Publication
(10) Pub. No.: US 2019/0213183 A1
(43) Pub. Date: Jul. 11, 2019

(54) NAVIGATION UPDATING METHOD AND DEVICE

(71) Applicant: SAMSUNG ELECTRONICS CO., LTD., Suwon-si (KR)

(72) Inventors: In-Young SHIN, Seoul (KR); Dong HE, Suwon-si, Gyeonggi-do (KR); Joo-Yeol LEE, Seongnam-si, Gyeonggi-do (KR); Se-Hee HAN, Seoul (KR)

(73) Assignee: SAMSUNG ELECTRONICS CO., LTD., Suwon-si (KR)

(21) Appl. No.: 16/333,150

(22) PCT Filed: Aug. 23, 2017
(86) PCT No.: PCT/KR2017/009211

§ 371 Date: Mar. 13, 2019

(30) Foreign Application Priority Data
Sep. 13, 2016 (KR) 10-2016-0118110

(51) Int. Cl. G06F 16/23; G06F 16/29; G01C 21/36

(52) U.S. Cl. CPC G06F 16/2379; G01C 21/36; G06F 16/29

(57) ABSTRACT

Disclosed are: a communication technique for merging, with an IoT technology, a 5G communication system for supporting a data transmission rate higher than that of a 4G system; and a system therefor. The disclosure can be applied to an intelligent service (for example, smart home, smart building, smart city, smart car or connected car, health care, digital education, retail, security and safety-related services, and the like) on the basis of a 5G communication technology and an IoT-related technology. A method for updating a navigation device, according to the disclosure, comprises the steps of: creating a communication channel with a terminal and transmitting, to the terminal through the communication channel, route information including at least one piece of location information set to be displayed on the navigation device; receiving, from the terminal, at least one piece of first additional information included within a predetermined threshold distance and matched to the at least one piece of location information on the basis of the route information; updating a database of the navigation device on the basis of the first additional information; and displaying the first additional information on the screen of the navigation device on the basis of the location information.

### CROSS-REFERENCE TO RELATED APPLICATION(S)

This application is a National Phase Entry of PCT International Application No. PCT/KR2017/009211, which was filed on Aug. 23, 2017 and claims priority under 35 U.S.C. § 119 to Korean Patent Application No. 10-2016-0118110, filed on Sep. 13, 2016, in the Korean Intellectual Property Office, the disclosure of which is incorporated herein by reference in its entirety.

### BACKGROUND

### 1. Field

The present invention relates to vehicle navigation updating schemes, and more specifically, to methods and devices for updating vehicle navigation using a terminal with communication functionality.

### 2. Description of Related Art

In order to meet the demand for wireless data traffic soring since the 4th generation (4G) communication system came to the market, there are ongoing efforts to develop enhanced 5th generation (5G) communication systems or pre-5G communication systems. For the reasons, the 5G communication system or pre-5G communication system is called the beyond 4G network communication system or post LTE system.

For higher data transmit rates, 5G communication systems are considered to be implemented on ultra high frequency bands (mmWave), such as, e.g., 60 GHz. To mitigate pathloss on the ultra high frequency band and increase the reach of radio waves, the following techniques are taken into account for the 5G communication system: beamforming, massive multi-input multi-output (MIMO), full dimensional MIMO (FD-MIMO), array antenna, analog beamforming, and large scale antenna.

Also being developed are various technologies for the 5G communication system to have an enhanced network, such as evolved or advanced small cell, cloud radio access network (cloud RAN), ultra-dense network, device-to-device (D2D) communication, wireless backhaul, moving network, cooperative communication, coordinated multi-point (CoMP), and interference cancellation.

There are also other various schemes under development for the 5G system including, e.g., hybrid FSK and QAM modulation (FQAM) and sliding window superposition coding (SWSC), which are advanced coding modulation (ACM) schemes, and filter bank multi-carrier (FBMC), non-orthogonal multiple access (NOMA) and sparse code multiple access (SCMA), which are advanced access schemes.

Meanwhile, the Internet is evolving from the human-centered connection network by which humans create and consume information to the Internet of Things (IoT) network by which information is communicated and processed between things or other distributed components. The Internet of Everything (IoE) technology may be an example of a combination of the Big data processing technology and the IoT technology through, e.g., a connection with a cloud server.

To implement the IoT, technology elements, such as a sensing technology, wired/wireless communication and network infra, service interface technology, and a security technology, are required. There is a recent ongoing research for inter-object connection technologies, such as the sensor network, Machine-to-Machine (M2M), or the Machine-Type Communication (MTC).

In the IoT environment may be offered intelligent Internet Technology (IT) services that collect and analyze the data generated by the things connected with one another to create human life a new value. The IoT may have various applications, such as the smart home, smart building, smart city, smart car or connected car, smart grid, health-care, or smart appliance industry, or state-of-art medical services, through conversion or integration of existing IT technologies and various industries.

Thus, there are various ongoing efforts to apply the 5G communication system to the IoT network. For example, the sensor network, machine-to-machine (M2M), machine type communication (MTC), or other 5G techniques are implemented by schemes, such as beamforming, multi-input multi-output (MIMO), and array antenna schemes. The above-mentioned application of the cloud radio access network as a Big data processing technique may be said to be an example of the convergence of the 5G and IoT technologies.

Meanwhile, navigation services may indicate the current location of a vehicle, calculate the optimal route to a desired destination, and provide a preview of the calculated route, guiding the user. A devices supporting such a navigation service may obtain the current location of the vehicle using the global positioning system (GPS) and provide the navigation service according to location information.

A navigation device equippable in a vehicle may update information intended for network using limited information, such as car area network (CAN) information (e.g., information to indicate the degree of the driver stepping on the gas pedal or information entered through a sensor in the vehicle, provided from the vehicle.

The following is three example methods for updating the navigation equipped in a vehicle using an external network, e.g., the Internet, of the vehicle.

First, the navigation device may directly access an information providing server over the Internet by way of tethering that the driver's smartphone or such mobile communication device provides, downloading and updating data. By this method, the navigation device may update all of map data or point-of-interest (POI) data files simultaneously or partially and in real-time download and update only necessary map data or POI data. However, such smartphone tethering-based method requires the user's manual connection between the smartphone and navigation device and updating at a particular time, and thus, users would highly be reluctant to adopt. Further, updating the navigation device with all the map or POI data files via smartphone tethering may result in the smartphone too much power and data consumption, and this result would not be different even when the update is carried out in real-time only on necessary partial data because the smartphone needs to remain tethered. Since the navigation device relies only on its own information or information that the software provider provides, the update frequency may be low, and no guarantee may be made for the accuracy of information provided.

Secondly, the navigation device may receive and update data using a public broadcasting frequency such as of the transport protocol expert group (TPEG). However, public broadcasting for digital multimedia broadcast (DMB) intended for TPEG mostly delivers slow, and unilateral-only data transmissions. Moreover, data transmission over public broadcasting requires an infrastructure, and thus, its application may be limited per nation or per area.

Lastly, the navigation device may directly access an information providing server through a separate communication modem mounted in the vehicle to proceed with updating. However, this way encounters some obstacles, such as a low percentage of vehicles packing a communication modem and being separately charged for data used on the communication modem.

Smartphone users may save membership cards, Gifticons, or discount coupons in their smartphone for future use, but they sometimes miss the time limit. Therefore, a need exists for a scheme for updating navigation with location-related information stored in the smartphone and displaying on the navigation screen.

### SUMMARY

According to the disclosure, there is provided a method and device for allowing a navigation device to update information in real-time using a smartphone.

According to the disclosure, there is provided a method and device for receiving and updating various additional data via a smartphone based on location information produced from a navigation device.

According to the disclosure, there is provided a method and device for advancing network services using smartphones' accessibility to ample information.

According to the disclosure, there is provided a method and device for allowing a navigation device to receive various pieces of information via a smartphone and displaying on the navigation screen.

According to the disclosure, a method for updating a navigation device comprises creating a communication channel with a terminal and transmitting route information to the terminal via the communication channel, the route information including at least one piece of location information scheduled to be displayed on the navigation device, receiving at least one piece of first additional information from the terminal based on the route information, the first additional information included within a predetermined threshold distance and matching the at least one piece of location information, updating a database of the navigation device based on the first additional information, and displaying the first additional information on a screen of the navigation device based on the location information.

According to the disclosure, a device configured to update a navigation device comprises a transceiver configured to create a communication channel with a terminal and transmit or receive information to/from the terminal via the communication channel and a controller configured to control transmitting route information to the terminal via the communication channel, the route information including at least one piece of location information scheduled to be displayed on the navigation device, receiving at least one piece of first additional information from the terminal based on the route information, the first additional information included within a predetermined threshold distance and matching the at least one piece of location information, updating a database of the navigation device based on the first additional information, and displaying the first additional information on a screen of the navigation device based on the location information.

According to the disclosure, a method for supporting an update of a navigation device comprises creating a communication channel with the navigation device and receiving route information from the navigation device, the route information including at least one piece of location information scheduled to be displayed on the navigation device, extracting at least one piece of first additional information included within a predetermined threshold distance based on the location information of the received route information among at least one piece of information including location information stored in a terminal, and transmitting the at least one piece of first additional information extracted to the navigation device.

According to the disclosure, a device configured to support an update of a navigation device comprises a transceiver configured to create a communication channel with the navigation device and transmit or receive information to/from the navigation device via the communication channel and a controller configured to control receiving route information from the navigation device, the route information including at least one piece of location information scheduled to be displayed on the navigation device, extracting at least one piece of first additional information included within a predetermined threshold distance based on the location information of the received route information among at least one piece of information including location information stored in the terminal, and transmitting the at least one piece of first additional information extracted to the navigation device.

According to the embodiments of the disclosure, navigation device may be updated with ample information gathered through a smartphone.

According to the embodiments of the disclosure, it is possible to provide user customized navigation information by displaying location information stored in a smartphone on the navigation.

### BRIEF DESCRIPTION OF THE DRAWINGS

FIG. 1 is a concept view illustrating a scheme for updating a navigation device according to an embodiment of the disclosure;

FIG. 2 is a view illustrating mutual operations and data flow between a navigation device and a smartphone according to an embodiment of the disclosure;

FIG. 3 is a view illustrating an example of a method for supporting a navigation update by a smartphone according to an embodiment of the disclosure;

FIG. 4 is a view illustrating an example of a method for updating a navigation device according to an embodiment of the disclosure;

FIGS. 5A, 5B, and 5C are views view illustrating an example of a screen output on a navigation device according to an embodiment of the disclosure;

FIG. 6 is a view illustrating an example of a configuration of a navigation device according to an embodiment of the disclosure; and

FIG. 7 is a view illustrating an example of a configuration of a user terminal according to an embodiment of the disclosure.

### DETAILED DESCRIPTION OF THE DISCLOSURE

Hereinafter, embodiments of the present disclosure are described in detail with reference to the accompanying drawings. When determined to make the subject matter of the present disclosure unclear, the detailed of the known functions or configurations may be skipped. The terms as used herein are defined considering the functions in the present disclosure and may be replaced with other terms according to the intention or practice of the user or operator. Therefore, the terms should be defined based on the overall disclosure.

Before detailing the present disclosure, some terms as used herein may be interpreted as follows, for example. However, it should be noted that the present disclosure is not limited thereto.

Navigation device is a device to provide navigation services and may be referred to as a ‘navigator’ or ‘navigation.’ Where a mobile device, e.g., smartphone, provides navigation services, the smartphone may also be referred to as a navigation device. In the disclosure, separate denotations “smartphone” and “navigation device” may be used to distinguish navigation devices incapable of cellular communications from smartphones which are capable of cellular communications. As used herein, ‘navigation device’ refers to a device capable of peer-to-peer (P2P) communications as well as wired communications using, e.g., USB, with a smartphone.

‘Smartphone’ is a mobile communication device capable of installing and running various applications and capable of cellular communications and P2P communications. As used herein, ‘smartphone’ does not simply denote a mobile phone but rather encompasses tablet PCs, smartwatches and such wearable devices, or other various smart devices. Smartphone may also be referred to as a user equipment (UE), mobile station (MS), mobile equipment (ME), device, or terminal.

P2P communication refers to an inter-device direct communication establishiable between a navigation device and a user's mobile communication device, e.g., smartphone. For example, a navigation device and a smartphone may establish a P2P communication by adopting various communication standards, e.g., Wi-Fi Direct, Bluetooth, ZigBee, or IPv6 over Low power Wireless Personal Area Network (6LoWPAN).

The operation of updating a navigation may include changing a database (DB) or screen of the navigation with additional data.

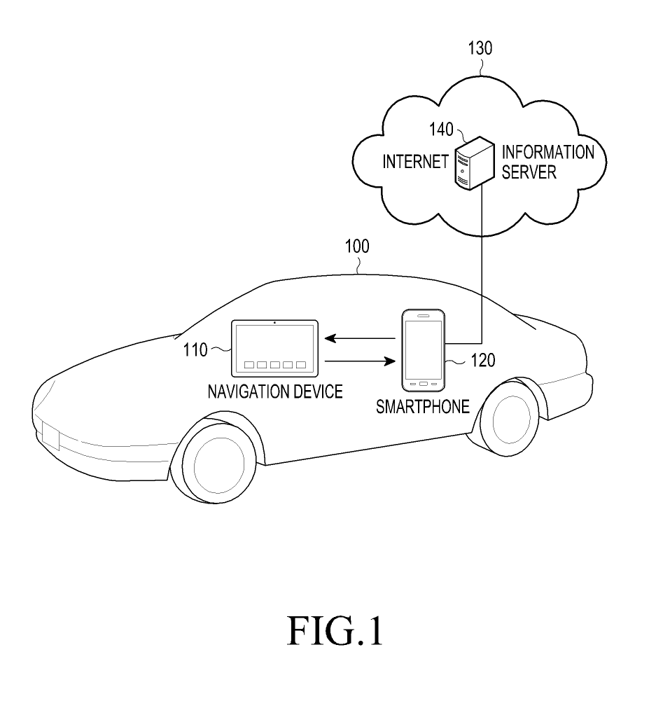

FIG. 1 is a concept view illustrating a scheme for updating a navigation device according to an embodiment of the disclosure.

A navigation device 110 provided in a vehicle 100 may establish a wired/wireless communication connection with a mobile communication device (such as a smartphone) that a user (or driver) carries automatically or the user's manipulation (via wired connection). The smartphone 120 may communicate with various information servers 140 over the Internet 130 and receive and store various pieces of information from the information servers 140. The smartphone 120 may receive various pieces of information from various sensors and wearable devices wirelessly connected or embedded inside. Thus, the navigation device 110 may obtain various pieces of information from various information servers 140 over the Internet 130 through the smartphone 120. In other words, according to the disclosure, the user's smartphone 120 may serve as an information source to provide various pieces of information to the navigation device 110.

As proposed herein, if communications and interoperations are rendered possible between the smartphone 120 and the navigation device 110, it is possible to display on the navigation device 110 various pieces of information obtained thanks to the smartphone 120's advantageous trait, i.e., easy access to the Internet. The navigation device 110 may frequently communicate with the smartphone 120 to update information, and the user may punctually check and use various pieces of information stored in the smartphone 120 through the navigation device 110.

The navigation device 110 may send route information as per a start point and destination set by the user's manipulation to the smartphone 120 via wired/wireless communications.

The smartphone 120 may gather and store various pieces of additional data from the information servers 140 through cellular communications or Wi-Fi communications using various applications installed thereon, screen and process ones matching the route information received from the navigation device 110 among the pieces of additional data, and send the resultant data to the navigation device 110 via wired/wireless communications.

The additional data which is processed and transmitted may include not only basic information to allow the navigation device 110 to provide the navigation service, such as map data, POI data, road information, and geographical name information, but also user customized information stored as per the user's interest.

The user customized information is information containing location information and the user customized information may include mobile gift cards, discount coupons, or free coupons stored in, e.g., the text inbox, gallery, or application of the smartphone 120. The user customized information may include various pieces of information including location information stored in, e.g., a scheduling application or messenger application of the smartphone 120. The user customized information may include location information including friends' locations or restaurants recommended by friends, stored in the social media application or contacts application of the smartphone 120. The user customized information may be gathered by inter-application communication (app-to-app communication) of the smartphone 120 and stored. Other various types of location information-related data obtained through the smartphone 120 may be used as user customized information.

The navigation device 110 may receive additional data from the smartphone 120 and update the navigation DB, displaying additional data information on the navigation screen at a proper time.

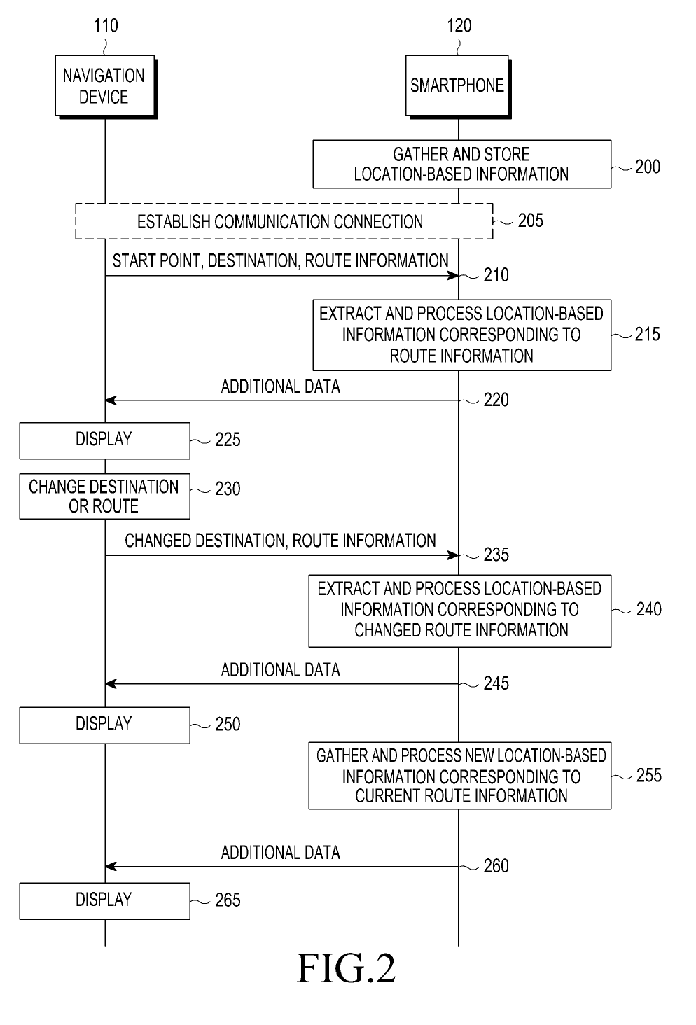

FIG. 2 is a view illustrating mutual operations and data flow between a navigation device and a smartphone according to an embodiment of the disclosure.

The smartphone 120 may previously gather and store location-based information (200). The gathering of location-based information may be carried out periodically at predetermined time intervals or upon each event when location-based information is registered in a preset application. The smartphone 120 may screen only meaningful information which is to be delivered to the navigation device 110 among the pieces of information gathered, based on, e.g., thumbnails, road names, GPS information, business names, or specific keywords, and store the information.

The navigation device 110 and the smartphone 120 may establish a wired/wireless communication connection (205). The communication connection establishment may follow a common P2P connection procedure and may include the process of exchanging capabilities and negotiating between the navigation device 110 and the smartphone 120. In other words, at a request from the smartphone 120, the navigation device 110 may send, e.g., a route information data format, a desired additional data format, or reception callback address to the smartphone 120. At a request from the navigation device 110, the smartphone 120 may send, e.g., the additional data format, desired route information data format, or reception callback address, thereby negotiating bi-lateral data transmission/reception formats.

The additional data format desired by the navigation device 110 may be, e.g., a data format (e.g., structured query language (SQL) query result dat) to be used to update the DB or various data formats for display on the screen of the navigation device 110 or a web data format (e.g., xml, widget, or image files) that may be recnfigured and output on the screen of the navigation device 110. The route information data format desired by the smartphone 120 may include location data mappable to the location-based information stored in the smartphone 120.

The navigation device 110 may send a request for subscribing to an event for receiving additional data from the smartphone 120, and the smartphone 120 may send a request for subscribing to an event for receiving route information from the navigation device 110.

After a communication connection is established between the navigation device 110 and the smartphone 120, the navigation device 110 may receive start point and destination information by the user's selection, e.g., a touch input to the navigation screen, search for route information, and send the start point, destination, and route information to the smartphone 120 (210).

The smartphone 120 extracts pieces of location-based information corresponding to the route information among pre-stored pieces of location-based information based on the start point, destination, and route information received from the navigation device 110 and process the information into additional data fitting the format desired by the navigation device 110 (215).

The additional data which is processed and transmitted may include not only basic information to allow the navigation device 110 to provide the navigation service, such as map data, POI data, road information, and geographical area name information, but also user customized information, e.g., coupon information or discount information, stored as per the user's interest. Examples of the basic information may include, e.g., detailed map data information, POI data information, new building information, new road information, or closed road information. Examples of the user customized information may include, e.g., free food coupon and discount information about a specific restaurant, price information about a specific gas station, price comparison information about gas stations, free car wash coupon information about a car wash, sale information about a department store, coupon information about a department store, and location information about friends' work places or homes registered in a specific application.

The additional data may be information stored in various servers (e.g., portal websites or search websites) over the Internet or information servers operated or supported by navigation hardware or software manufacturers or information already stored in the smartphone 120. The smartphone 120 may obtain additional information from the information servers in real-time and process the additional information, or the smartphone 120 may process additional information that it already stores into additional data to be sent.

The smartphone 120 sends the processed additional data to the navigation device 110 (220).

The navigation device 110 performs an update using the received additional data and displays the additional data along with the basic map data on the screen at a proper time (i.e., when the location corresponding to the additional data is included in the current map) (225). The navigation device 110 may display on the screen the additional data in the form of a tooltip, dialogue window, icon, or button or to be partially overlaid on the screen.

Meanwhile, where the navigation device reroutes automatically due to, e.g., a traffic change, or by the user's input to, e.g., change the destination while directing along the route (230), the navigation device 110 may send the changed route information to the smartphone 120 (235). Upon receiving the changed route information, the smartphone 120 may screen and process (240) pieces of additional data matching the changed route information received from the navigation device 110 among pieces of additional data previously gathered and stored and send the resultant additional data to the navigation device 110 via wired/wireless communications (245). The navigation device 110 performs an update using the received additional data and displays the additional data along with the basic map data on the screen at a proper time (i.e., when the location corresponding to the additional data is included in the current map) (250). Operations 230 to 250 may be performed whenever the route information of the navigation device 110 is changed.

Whenever new location-based information is obtained, the smartphone 120 may identify whether the information corresponds to the current route information, and where corresponding to the current route information, process the location-based information into new additional data and send the new additional data to the navigation device 110 (255 and 260). Further, the navigation device 110 performs an update using the received new additional data and displays the additional data along with the basic map data on the screen at a proper time (i.e., when the location corresponding to the additional data is included in the current map) (265). Steps 255 to 265 may be performed whenever the smartphone 120 obtains new location-based information.

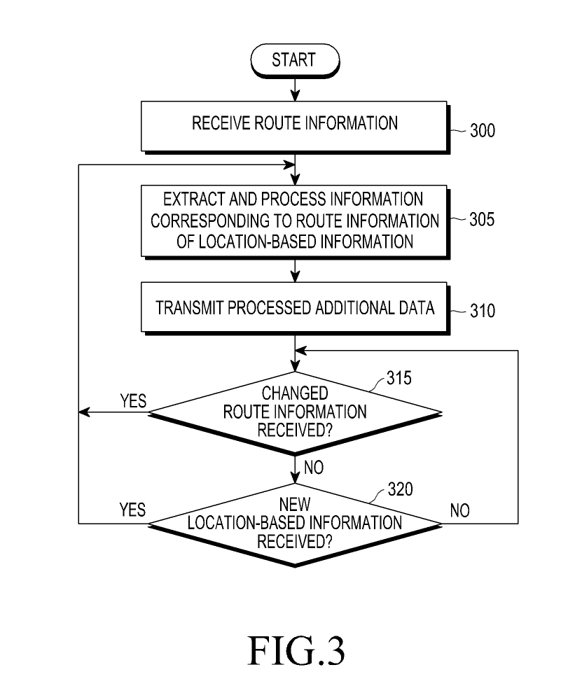

FIG. 3 is a view illustrating an example of a method for supporting a navigation update by a smartphone according to an embodiment of the disclosure. It is assumed in connection with FIG. 3 that a smartphone has already established a communication connection with a navigation device and that the smartphone communicates with ample information servers over the Internet, receive various pieces of information from the information servers, and stores the information.

The smartphone receives location information-based route information from the navigation device (300). The smartphone has already gathered and stored various pieces of additional information, including location information, from various information servers over the Internet through cellular communications or Wi-Fi communications, and the smartphone screens pieces of information matching route information received from the navigation device among the pieces of information already stored, and processes the screened pieces of additional information into a data format for transmission to the navigation device (305). The screened additional information may be processed into a desired data format requested by the navigation device. The additional data transmitted to the navigation device may be in a data format for DB update, a streaming data format, or a web data format such as of web widgets, xml, or image files.

The smartphone may screen pieces of location-based information within a predetermined threshold distance (e.g., 500 m or 1 km) from a predicted route based on the route information received from the navigation device.

At this time, the threshold distance for screening additional information matching the route information may be determined considering various parameters. The parameters may be, e.g., preference information directly set by the user, common information, e.g., time, location-related text information stored a predetermined number of times or more in a specific application, or information to indicate the state of the vehicle, e.g., vehicle abnormality or fuel gauge information. The preference information directly set by the user may be information about, e.g., a specific business name, such as of a department store, discount shop, outlet, gas station, or restaurant, or a friend's home or work place stored in a messenger application or contacts application. The preference information may also include information received from various sensors or wearable smart devices wiredly or wirelessly connected with, or embedded in, the smartphone. The preference information may be obtained via app-to-app communications. For app-to-app communications, the smartphone may be previously chosen and designated to obtain location-based information from a specific application. The information to indicate the state of the vehicle, such as vehicle abnormality or fuel gauge information may be obtained by the smartphone performing wired or wireless communications with the vehicle.

The threshold distance may be a fixed distance or be varied by parameters that are adaptively varied depending on the context in which the navigation device directs the driver along the route. For example, where the current time is in the evening, additional data related to restaurants within the threshold distance based on time parameters may be assigned a higher priority and be screened. Upon receiving information indicating that fueling is required from a vehicle maintenance application or the vehicle, the smartphone may raise the priority of, and screen, additional data related to gas stations within the threshold distance. Upon receiving a signal indicating a sensing of abnormal beat from a beat measuring sensor, the smartphone may screen additional data related to hospital within the threshold distance.

The smartphone sends the processed additional data to the navigation device (310).

Upon receiving the changed route information from the navigation device (315), the smartphone screens pieces of additional information included within the threshold distance among pieces of additional information matching the changed route information received from the navigation device among the pieces of additional information stored, process the information into a data format for transmission to the navigation (305), and sends the processed additional data to the navigation device (310). Such process is repeated whenever receiving changed route information from the navigation device.

Upon receiving new additional information including location information from various information servers over the Internet through cellular communications or Wi-Fi communications (320), the smartphone may identify whether the new additional information is included within the threshold information as per the route information received from the navigation device, if included in the threshold distance, processes the information into a data format for transmission to the navigation (305), and sends the processed additional data to the navigation device (310). Such process is repeated whenever the smartphone receives new additional information.

The operation when the smartphone receives new additional information and the operation when the changed route information is received are performed whenever the corresponding events occur on the smartphone regardless of which one is carried out first.

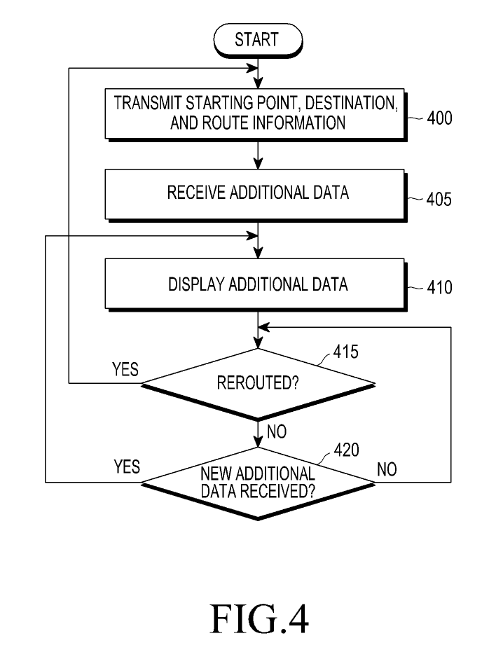

FIG. 4 is a view illustrating an example of a method for updating a navigation device according to an embodiment of the disclosure. It is assumed in connection with FIG. 4. that a smartphone has already established a communication connection with a navigation device and that the smartphone communicates with ample information servers over the Internet, receive various pieces of information from the information servers, and stores the information.

The navigation device receives start point and destination information by the user's selection such as a touch input to the navigation screen, searches for route information, and transmits the start point, destination, and route information searched for to the smartphone (400). The route information transmitted to the smartphone may be data matching the format desired by the smartphone and contains location information. The location information may be GPS coordinates information or administrative district address information.

The navigation device receives additional data from the smartphone (405). The additional data is data resulting from processing pieces of additional information included in the threshold distance among pieces of additional information matching the route information transmitted from the navigation device to the smartphone. The additional data may include various pieces of additional information used for updating the navigation device. The additional information may be received in a desired data format requested by the navigation device. That is, the additional data received may be in a data format for DB update, a streaming data format, or a web data format such as of web widgets, xml, or image files.

The navigation device updates the navigation DB using the received additional data and outputs a screen as per the updated DB (410). Specifically, the updated DB contains the additional data received from the smartphone. If there is additional data corresponding to the location displayed on the current screen while directing along the route, the additional data along with a map is displayed on the screen. The navigation device may display on the screen the additional data in the form of a tooltip, dialogue window, icon, or button or to be partially overlaid on the screen.

Where the navigation device reroutes automatically due to, e.g., a traffic change, or by the user's input to, e.g., change the destination while directing along the prior route (415), the navigation device 400 may send the changed route information to the smartphone 120 (400) and receives again additional data corresponding to the changed route information (405). The additional data received again is data resulting from processing pieces of additional information included in the threshold distance among pieces of additional information matching the changed route information transmitted from the navigation device to the smartphone. The navigation device updates the DB using the received new additional data and displays the additional data along with the map on the screen at a proper time (i.e., when the location corresponding to the additional data is included in the current map) (410). Operations 400, 405, and 410 may be performed whenever the route information of the navigation device is changed.

Upon receiving new additional data from the smartphone (420), the navigation device udpates the DB using the new additional data and displays the additional data along with the basic map data on the screen at a proper time (i.e., when the location corresponding to the additional data is included in the current map) (410). Operations 420 and 410 may be performed whenever new additional data is received from the smartphone.

The operation when the navigation device receives new additional information and the operation when the route information is changed are performed whenever the corresponding events occur on the navigation device regardless of which one is carried out first.

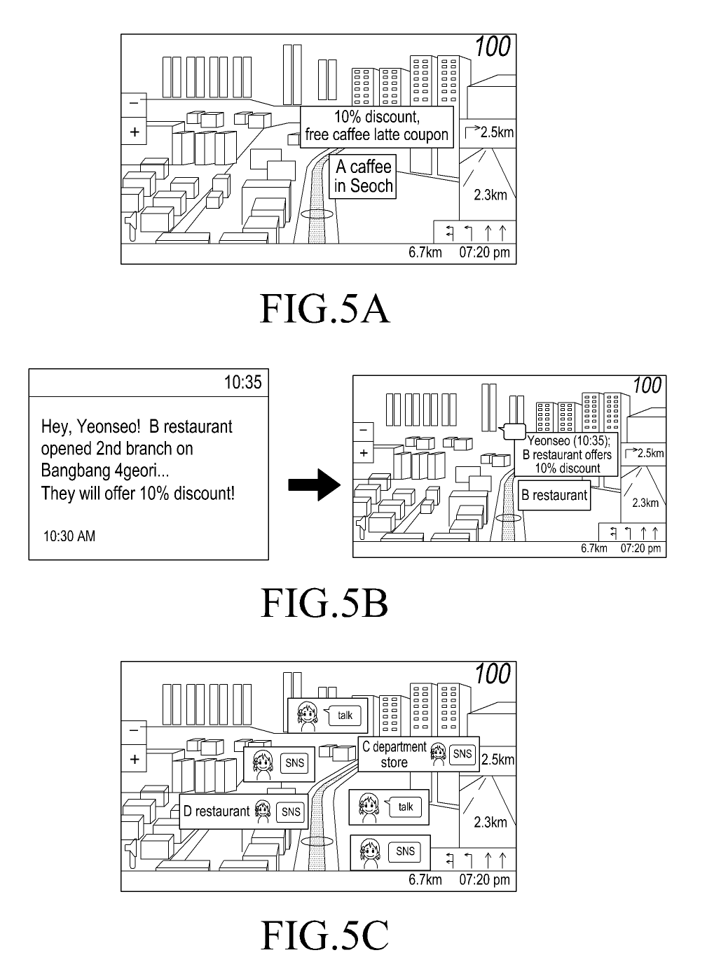

FIGS. 5A, 5B, and 5C are views view illustrating an example of a screen output on a navigation device according to an embodiment of the disclosure.

FIG. 5A illustrates an example in which a smartphone sends a navigation device a 10% discount coupon and free caffe latte coupon from caffe A in Seoch, among coupons that it stores, as additional data, based on route information received form the navigation device. When A caffee in Seocho is included in an area to be displayed on the screen while directing along the route, the navigation device may display information related to the 10% discount coupon and free caffe latte coupon of A caffee in Seocho received from the smartphone near A caffee in Seocho on the map.

FIG. 5B illustrates an example in which a smartphone extracts discount information offered from the second B restaurant from the conversation with a friend stored in the Kakaotalk application based on route information received from a navigation device and sends the extracted information, as additional data, to the navigation device. When the second B restaurant is included in an area to be displayed on the screen while directing along the route, the navigation device may display the conversation related to the second B restaurant received from the smartphone near the second B restaurant on the map. In this case, the navigation device may display the whole conversation including the other party, date, and time information or only a particular keyword.

FIG. 5C illustrates an example in which a smartphone extracts location information about a friend stored in an application, e.g., a social media or contacts application, based on route information received from a navigation device and sends the extracted information, as additional data, to the navigation device. When the friend's work place or school is displayed on an area to be displayed on the screen while directing along the route, the navigation device may display the friend's name received from the smartphone on the screen. The navigation device may display an image to indicate the corresponding application along with the friend's name.

Upon displaying the additional data received from the smartphone on the screen, the navigation device may reconfigure the screen, e.g., by shrinking the image being currently displayed or relocating to another position (e.g., to the left, right, top, bottom, or center) to secure an area for displaying the additional data. The navigation device may output the additional data regarding the specific position or object on the whole or part of the area secured by screen reconfiguration. The additional data may be in such a form as of a tooltip, dialogue window, button, or icon. The navigation device may output the additional data within a predetermined time or range, and upon exceeding the time or range, remove the additional data from the screen while displaying back the prior full screen.

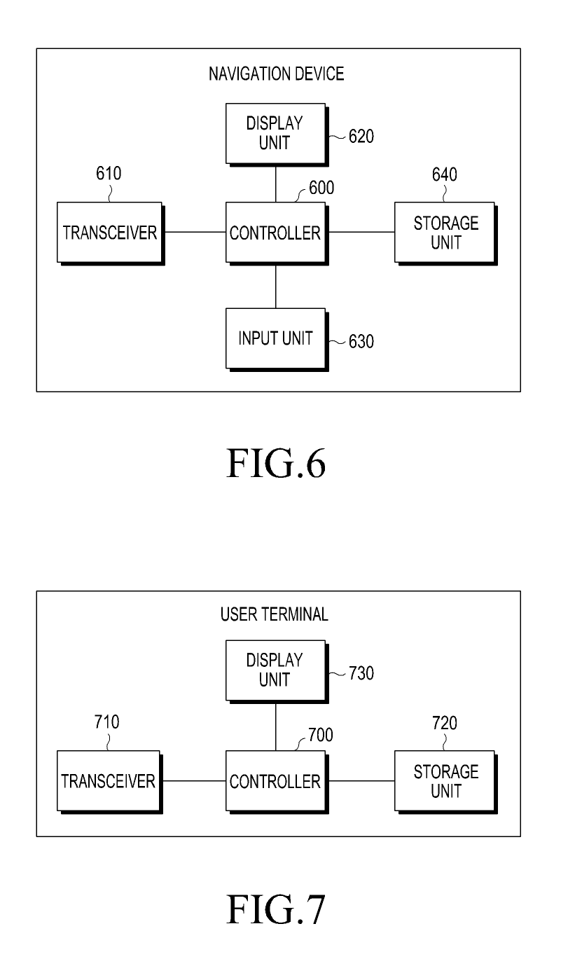

FIG. 6 is a view illustrating an example of a configuration of a navigation device according to an embodiment of the disclosure.

A navigation device may include at least one of a transceiver 610 to transmit or receive signals to/from a smartphone, a display unit 620 to display screens, an input unit 630 to receive information, commands, or choices from a user, and a controller 600 to control the operations of the transceiver 610, the display unit 620, and the input unit 630. The navigation device may further include a storage unit 640 to store data transmitted or received. The storage unit 640 may store additional data and DB files received from the smartphone for update.

The display unit 620 may be configured with a touchscreen for recognizing the user's touch, such as a light emitting diode (LED), liquid crystal display (LCD), thin film transistor (TFT)-LCD, organic light emitting diode (OLED), active matrix organic LED (AMOLED), flexible display, or three-dimensional (3D) display. The display unit 620 may perform the same function as the input unit 630 in which case the input unit 630 may be excluded.

As set forth above, the input unit 630 may have the same configuration as the display unit 620 and the input unit 630 may include a microphone and voice recognition module to recognize the user's voice.

The controller 600 may be interpreted as performing all the operations of the navigation device 110 as described above. That is, the controller 600 may control the display unit 620, the transceiver 610, the input unit 630, and the storage unit 640 to control at least one of transmitting route information to the smartphone, receiving additional data from the smartphone, and updating the DB using the received additional data and displaying on the screen.

Although the navigation device is described to have multiple distinct components in connection with FIG. 6, at least two or more of the components may be implemented in a single component. For example, the controller 600, the transceiver 610, and the storage unit 640 may be implemented in a single module.

FIG. 7 is a view illustrating an example of a configuration of a user terminal (smartphone) according to an embodiment of the disclosure.

A smartphone may include at least one of a transceiver 710 to receive data from information servers over the Internet via cellular communications or Wi-Fi communications and perform wired/wireless communication with a navigation and a controller 700 to control the operation of the transceiver 710. The smartphone may further include at least one of a storage unit 720 to store data received from the information servers and a display unit 730 to display screens.

The controller 700 may be interpreted as performing all the operations of the smartphone 120 as described above. That is, the controller 700 may control the transceiver 710 or the storage unit 720 to control at least one of receiving route information from the navigation device, screening and processing additional data that it gathers from the information servers over the Internet and stores based on the route information, and sending the processed additional data to the navigation device.

It should be noted that the system configuration, the network update process and methods using a smartphone and example screens for the methods, the navigation device update methods, the smartphone's network update supporting, and the navigation device's configuration as shown and exemplified in FIGS. 1 to 7 are not intended as limiting the scope of the disclosure. In other words, all the components or operational steps illustrated in FIGS. 1 to 7 should not be construed as essential components to practice the present invention, and the present invention may be rather implemented with only some of the components without departing from the gist of the disclosure.

The above-described operations may be realized by equipping a memory device retaining their corresponding codes in any component of the navigation device or smartphone. That is, the controller in the navigation device or smartphone may execute the above-described operations by reading and executing the program codes stored in the memory device by a processor or central processing unit (CPU).

As described herein, various components or modules in the navigation device or smartphone may be operated using a hardware circuit, e.g., a complementary metal oxide semiconductor-based logic circuit, firmware, software, and/or using a hardware circuit such as a combination of hardware, firmware, and/or software embedded in a machine-readable medium. As an example, various electric structures and methods may be executed using electric circuits such as transistors, logic gates, or ASICs.

Although specific embodiments of the present disclosure have been described above, various changes may be made thereto without departing from the scope of the present disclosure. Thus, the scope of the disclosure should not be limited to the above-described embodiments, and should rather be defined by the following claims and equivalents thereof.

1. A method for updating a navigation device, the method comprising:
generating a communication channel with a terminal and transmitting route information to the terminal via the communication channel, the route information including at least one piece of location information scheduled to be displayed on the navigation device;
receiving at least one piece of first additional information from the terminal based on the route information, the first additional information included within a predetermined threshold distance and matching the at least one piece of location information;
updating a database of the navigation device based on the first additional information; and
displaying the first additional information on a screen of the navigation device based on the location information.

2. The method of claim 1, further comprising:
where the route information is changed, transmitting the changed route information to the terminal via the communication channel;
receiving at least one piece of second additional information from the terminal based on the changed route information, the second additional information included within the predetermined threshold distance and matching at least one piece of location information included in the changed route information;
updating the database of the navigation device based on the second additional information; and
displaying the second additional information on the screen of the navigation device based on the location information.

3. The method of claim 1, further comprising:
receiving at least one piece of third additional information from the terminal based on the route information, the third additional information included within the predetermined threshold distance and matching at least one piece of location information included in the route information;
updating the database of the navigation device based on the third additional information; and
displaying the third additional information on the screen of the navigation device based on the location information.

4. The method of claim 2, wherein when an object corresponding to the location information is displayed on the screen of the navigation device, the first, second, or third additional information along with the object is displayed around the object.

5. The method of claim 2, wherein the first, second, or third additional information is configured based on a desired data format transmitted to the terminal while generating the communication channel with the terminal.

6. The method of claim 2, wherein the first, second, or third additional information is user customized information stored in the terminal as per a user's interest.

7. The method of claim 1, wherein the predetermined threshold distance is determined based on at least one parameter preset as per a user's interest.

8. A navigation device configured to perform an update, comprising:
a transceiver configured to generate a communication channel with a terminal and transmit or receive information to/from the terminal via the communication channel; and
a controller configured to control transmitting route information to the terminal via the communication channel, the route information including at least one piece of location information scheduled to be displayed on the navigation device, receiving at least one piece of first additional information from the terminal based on the route information, the first additional information included within a predetermined threshold distance and matching the at least one piece of location information, updating a database of the navigation device based on the first additional information, and displaying the first additional information on a screen of the navigation device based on the location information.

9. A method for supporting an update of a navigation device, the method comprising:
generating a communication channel with the navigation device and receiving route information from the navigation device, the route information including at least one piece of location information scheduled to be displayed on the navigation device;
extracting at least one piece of first additional information included within a predetermined threshold distance based on the location information of the received route information among at least one piece of information including location information stored in a terminal; and
transmitting the at least one piece of first additional information extracted to the navigation device.

10. The method of claim 9, further comprising:
receiving changed route information from the navigation device;
extracting at least one piece of second additional information included within the predetermined threshold distance based on the location information of the changed route information among the at least one piece of information including the location information stored in the terminal; and
transmitting the at least one piece of second additional information extracted to the navigation device.

11. The method of claim 9, further comprising:
receiving at least one piece of new information including location information from an information server over an internet;
extracting at least one piece of third additional information included within the predetermined threshold distance based on the location information of the received route information among the at least one piece of new information; and
transmitting the at least one piece of third additional information extracted to the navigation device.

12. The method of claim 10, wherein the first or second additional information is used to update a database of the navigation device and, when an object corresponding to the location information is displayed on the screen of the navigation device, the first, second, or third additional information along with the object is displayed around the object,
or
wherein the first or second additional information is user customized information stored in the terminal as per a user's interest.

13. The method of claim 10, wherein the first or second additional information is configured based on a desired data format transmitted to the terminal while creating the communication channel with the terminal.

14. The method of claim 11, wherein the third additional information is user customized information stored in the terminal as per a user's interest.

15. A terminal configured to support an update of a navigation device, comprising:
a transceiver configured to generate a communication channel with the navigation device and transmit or receive information to/from the navigation device via the communication channel; and
a controller configured to control receiving route information from the navigation device, the route information including at least one piece of location information scheduled to be displayed on the navigation device, extracting at least one piece of first additional information included within a predetermined threshold distance based on the location information of the received route information among at least one piece of information including location information stored in the terminal, and transmitting the at least one piece of first additional information extracted to the navigation device

16. The method of claim 3, wherein when an object corresponding to the location information is displayed on the screen of the navigation device, the third additional information along with the object is displayed around the object.

17. The method of claim 3, wherein the third additional information is configured based on a desired data format transmitted to the terminal while creating the communication channel with the terminal.

18. The method of claim 3, wherein the third additional information is user customized information stored in the terminal as per a user's interest.

19. The method of claim 11, wherein the third additional information is used to update a database of the navigation device and, when an object corresponding to the location information is displayed on the screen of the navigation device, the first, second, or third additional information along with the object is displayed around the object.

20. The method of claim 11, wherein the third additional information is configured based on a desired data format transmitted to the terminal while creating the communication channel with the terminal.
